(19) United States
(12) Patent Application Publication
(10) Pub. No.: US 2025/0294132 A1
(43) Pub. Date: Sep. 18, 2025

(54) RETRO-REFLECTIVE SHOW ELEMENT SYSTEMS AND METHODS

(71) Applicant: Universal City Studios LLC, Universal City, CA (US)

(72) Inventors: Akiva Meir Krauthamer, Orlando, FL (US); Aaron Chandler Jeromin, Winter Garden, FL (US)

(21) Appl. No.: 19/081,852

(22) Filed: Mar. 17, 2025

Related U.S. Application Data
(60) Provisional application No. 63/566,775, filed on Mar. 18, 2024.

(51) Int. Cl. H04N 13/302; A63G 31/00; A63G 33/00; H04N 13/398

(52) U.S. Cl. CPC H04N 13/302; A63G 31/00; A63G 33/00; H04N 13/398

(57) ABSTRACT

An entertainment attraction for an entertainment venue includes a retro-reflective object including a retro-reflective layer configured to directionally reflect light, a transparent layer configured to enable passage of the light towards the retro-reflective layer, and a translucent layer overlaid onto the transparent layer and configured to provide the retro-reflective object with one or more light effects. The entertainment attraction also including a light source configured to direct the light to the retro-reflective object.

### CROSS-REFERENCE TO RELATED APPLICATION

This application claims priority from and the benefit of U.S. Provisional Application Ser. No. 63/566,775, entitled “RETRO-REFLECTIVE SHOW ELEMENT SYSTEMS AND METHODS,” filed Mar. 18, 2024, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks and other entertainment venues often provide a selection of unique attractions. For example, an amusement park may include a variety of attractions, such as rides and show performances, to entertain guests.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, an entertainment attraction for an entertainment venue includes a retro-reflective object including a retro-reflective layer configured to directionally reflect light, a transparent layer configured to enable passage of the light towards the retro-reflective layer, and a translucent layer overlaid onto the transparent layer and configured to provide the retro-reflective object with one or more light effects. The entertainment attraction also including a light source configured to direct the light to the retro-reflective object.

In an embodiment, an entertainment attraction for an entertainment venue, includes a retro-reflective object including a retro-reflective layer configured to directionally reflect light, a transparent layer configured to enable passage of the light towards the retro-reflective layer, and a translucent layer overlaid onto the transparent layer and configured to provide the retro-reflective object with one or more light effects. The entertainment attraction also includes a sensor (e.g., light source sensor) configured to detect an application of the light to the retro-reflective object and a controller communicatively coupled to the sensor. The controller is configured to identify the application of the light to the retro-reflective object and, based on identifying the application of the light to the retro-reflective object provide, via a display associated with a guest of the entertainment attraction, an indication associated with the retro-reflective object.

In an embodiment, a retro-reflective object for an entertainment venue includes a retro-reflective layer configured to receive light from a light source and directionally reflect the light back towards the light source. The retro-reflective object also includes a scrim layer configured to at least partially block passage of light to the retro-reflective layer, from the retro-reflective layer, or both and a transparent layer configured to enable passage of the light towards the retro-reflective layer. The retro-reflective object also includes a translucent layer overlaid onto the scrim layer and configured to provide the retro-reflective object with one or more light effects.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of an attraction with retro-reflective features, in accordance with the present disclosure;

FIG. 2 is a schematic illustration of an embodiment of an attraction with three-dimensional retro-reflective features, in accordance with the present disclosure;

FIG. 3 is a schematic illustration of an embodiment of a ride attraction with retro-reflective features, in accordance with the present disclosure; and

FIG. 4 is a side view of retro-reflecting material with a scrim layer, in accordance with the present disclosure.

### DETAILED DESCRIPTION

When introducing elements of various embodiments of the present disclosure, the articles “a,” “an,” and “the” are intended to mean that there are one or more of the elements. The terms “comprising,” “including,” “having,” and “based on” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is presently recognized that while participating in an attraction (e.g., ride, game, entertainment attraction) it may be desirable for guests of the attraction to discover (e.g., uncover) or find certain hidden objects. It is also presently recognized that when a first guest discovers a hidden object, it may be undesirable for a second guest to inadvertently perceive the discovered hidden object due to efforts of the first guest. As such, it is also presently recognized that it would be desirable to allow the first guest to discover the hidden object, without inadvertently alerting the second guest of a location of the hidden object.

The present disclosure is directed to retro-reflecting objects, which may be utilized within an attraction (e.g., ride, omni mover ride, rollercoaster, game, haunted house, escape room, performance stage, maze, walkway or path, scenery, store display, window display, other show area, and/or any other type of attraction or entertainment attraction) at an entertainment venue (e.g., amusement park, theatre, sports arena, hotel, restaurant, retail location, and/or any other type of venue). The retro-reflective object may reflect light back to certain guest(s), while appearing dark to other guest(s) within a similar location.

For example, in an embodiment, a retro-reflective object may include a retro-reflective layer and a transparent layer overlaying the retro-reflective layer. The retro-reflective object may also include a translucent layer (e.g., a semi-transparent layer), such as translucent paint and/or color application, that may define or otherwise create an image (e.g., animated character, shape, word) on the transparent layer. As a light source (e.g., flashlight, laser) shines light at the retro-reflective object, light enters the transparent layer and through the translucent layer, and then the light will be reflected by the retro-reflective layer, back through the transparent layer and the translucent layer and back toward the light source. In this way, the image defined by the translucent layer on the transparent surface may appear to be glowing or otherwise lit up from a perspective of the light source (e.g., an area immediately surrounding the light source). As will be appreciated, the retro-reflective object may be configured to reflect light back only to the area immediately around the light source, and not to other areas. As such, the image may not appear glowing or lit up from a perspective away from the light source.

In an embodiment, the retro-reflective object may be a part (e.g., a show element, a ride element, a game element) of an attraction. For example, the retro-reflective object may be hidden about an entertainment venue where guests are tasked with discovering or finding hidden objects. The guests may each have access to a light source (e.g., flashlight, lamp, headlamp, spotlight, electronic torch), and the guests are then tasked with manipulating (e.g., adjusting, moving, aiming) the light source to find the hidden objects (e.g., hidden retro-reflective objects). For example, upon a first guest directing light from their light source at a hidden object, the light may reflect from the hidden object back toward their light source, thereby creating a perceived glowing effect from the hidden object as viewed by the first guest. In this way, the first guest may recognize the hidden object has been found. Further, other guests participating in the attraction, but not within the immediate vicinity of the first guest, may not perceive the glowing visual effect of the hidden object. As such, the other guests may still be entertained by attempting to find and/or finding the hidden object using their own light source.

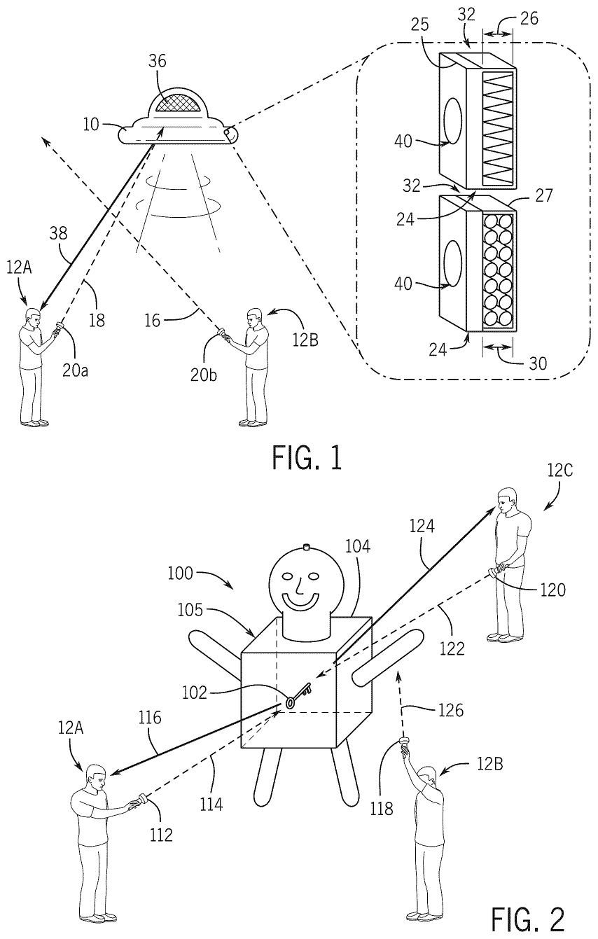

With the preceding in mind, FIG. 1 is a perspective view of an embodiment of a retro-reflective object 10 (e.g., show element, attraction element, image, two-dimensional (2D) object, three-dimensional (3D) object), which may be used in an attraction. The retro-reflective object 10 may be positioned in any suitable location within the attraction. For example, the retro-reflective object 10 may be located on a wall, ceiling, floor of a venue, on or within an animated robotic figure, on or within a show prop, on or within an enclosure, outdoors, indoors, and/or any other suitable location. In an embodiment, multiple retro-reflective objects 10 may be positioned throughout the attraction and/or throughout a venue that includes the attraction (e.g., in common areas, restaurants, and/or multiple attractions). In the illustrated example, guests 12 may also be referred to herein as “the first guest 12A” and “the second guest 12B” to facilitate discussion. As will be appreciated, upon application of light 18 from a light source 20a (e.g., first light source; flashlight), the retro-reflective object 10 may produce a glowing visual effect for the first guest 12A, even where the location is already lighted (e.g., during the day time).

The retro-reflective object 10 may include various different characteristics (e.g., materials) to provide the first guest 12A with a glowing visual effect upon application of the light 18 from the first light source 20a. As described herein, the retro-reflective object 10 may include a transparent layer 24 configured to allow passage of the light 18 to reach a retro-reflective layer 26, 30. Additionally, the transparent layer 24 may also be configured to block particulates from entering the retro-reflective layer 26, 30, protecting the retro-reflective qualities. The retro-reflective layer 26, 30 is configured to reflect and direct the light 18 back to the first light source 20a with minimal or no scattering. In the illustrated embodiment, the retro-reflective material 32 includes two configurations, a first configuration 25 with a corner retro-reflective layer 26 and a second configuration 27 with a spherical (e.g., cat's eye) retro-reflective layer 30. As will be appreciated, the retro-reflective material 32 may include the first configuration 25, the second configuration 37, or both. In any case, the retro-reflective layer 26, 30 may be configured to reflect the light 18 back towards the first light source 20a with minimal or no light scattering. In FIG. 1, the transparent layer 24 and the retro-reflective layer 26, 30 are planar layers and/or are coupled together (e.g., contact one another; one overlaid or formed on the other; without a gap or with a relatively small gap, such as less than 1, 2, or 3 centimeters. However, the transparent layer 24 and the retro-reflective layer 26, 30 may be formed to have a curvature and/or other geometry (e.g., 3D).

Further, in an embodiment, the retro-reflective object 10 may further include translucent layer 40 (e.g., semi-transparent layer, colored layer), such as translucent paint and/or color application (e.g., a translucent sticker), configured to provide one or more effects (e.g., light effects, visual effects) to the retro-reflective object 10, such as a colored effect (e.g., a hue, a pigment, a color besides white). The translucent layer 40 may include colored pigments configured to alter (e.g., change color) of reflected light 38 that exits from the retro-reflecting object 10. In an embodiment, the translucent layer 40 may define an image (e.g., a colored image) of the retro-reflective object 10. In an embodiment, the translucent layer 40 may not interfere with the retro-reflecting qualities of a respective retro-reflective layer 26, 30. For example, the translucent layer 40 may not noticeably reduce, diminish or otherwise dampen an intensity of the glowing visual effect as perceived by the guest 12A, 12B upon application of the light 16, 18, respectively. In this way, upon application of the light 16, 18, the guest 12A, 12B may perceive a colored image defined by the translucent layer 40 as having a glowing visual effect, without the use of electronics on the retro-reflective object 10 to provide or create the glowing visual effect.

In an embodiment, the retro-reflective object 10 may also include materials that absorb or otherwise do not reflect light (e.g., absorb light, scatter light, and/or, in contrast to the retro-reflective material 32, do not reflect light with minimal scattering). For example, an opaque element 36 of the retro-reflective object 10 may include opaque, non-transparent, and/or non-reflecting material that does not reflect light. In an embodiment, the opaque element 36, may be disposed on and/or within (e.g., embedded) the transparent layer 24 and configured to provide the retro-reflective object 10 with one or more non-reflecting areas. In an embodiment, the opaque element 36 may at least partially define the image, in conjunction with the translucent layer 40. In the illustrated example, the opaque element 36 may be surrounded (e.g., circumscribed) by the retro-reflective material 32 which may give the appearance of the opaque element 36 having a halo of surrounding light when the light 16, 18 reflects from the retro-reflective material 32. It should be noted that the retro-reflective object 10 may include any number of layers (e.g., 1, 2, 4, 5, 6, or more) including any composition (e.g., transparent, translucent, opaque, reflecting, retro-reflecting, colored) to achieve a desired image and desired glowing visual effect.

In the illustrated example, the guests 12, also referred to herein as “the first guest 12A” and “the second guest 12B” to facilitate discussion, may be partaking in a game or other attraction, and may be tasked with discovering or finding a hidden object or objects (e.g., the retro-reflective object 10). The guests 12 may also operate the light sources 20a, 20b also referred to herein as “the first light source 20a” and “the second light source 20b” to facilitate discussion. For example, the first guest 12A may operate the first light source 20a and the second guest 12B may operate the second light source 20b. The first light source 20a and the second light source 20b may include any suitable portable light source (e.g., laser, lamp, headlamp, cellular telephone light, projector) that may be carried (e.g., held, worn) and/or manipulated by the first guest 12A and the second guest 12B, respectively, to discover (e.g., find, locate, illuminate, uncover) the hidden object or objects.

That is, the first guest 12A may point or otherwise manipulate the first light source 20a to direct the light 18 emitted by the first light source 20a at various locations in and/or around the attraction. Upon shining (e.g., pointing) the first light source 20a at the hidden object (e.g., retro-reflective object 10) the first guest 12A may perceive the glowing visual effect produced by the hidden object, thereby alerting the first guest 12A to having found the hidden object. Further, the second guest 12B and/or other guests within the attraction may not perceive the glowing visual effect and thereby may not become aware of a location of the hidden object, due to the minimal light scattering of the retro-reflective object 10.

For example, during an attraction where the guests 12 are tasked with discovering or finding a hidden object, such as the retro-reflective object 10, the first guest 12A may shine or otherwise direct the light 18 from the first light source 20a in a direction of the retro-reflective object 10. In consequence, reflected light 38 may be directed back to the first guest 12A, thereby creating a glowing visual effect for the first guest 12A. As described herein, the minimal scattering of the reflected light 38 after reflecting from the retro-reflecting object 10 may block (e.g., prevent) the second guest 12B, positioned away from the first guest 12A, from receiving the reflected light 38 or viewing the glowing visual effect caused by the reflected light 38. As such, the second guest 12B may still receive a desired experience from discovering or finding hidden objects, without becoming inadvertently aware of the location of the retro-reflective object 10 due to the actions of the first guest 12A.

FIG. 2 illustrates an embodiment of a three-dimensional (3D) object 100 (e.g., a 3D retro-reflective object). For example, the 3D object 100 may include a transparent layer 104 over a retro-reflective object 102 (e.g., a retro-reflective layer). In an embodiment, the transparent layer 104 is formed into a body (e.g., hollow structure; housing) that includes or houses (e.g., surrounds, covers) the retro-reflective object 102 (e.g., the retro-reflective object 102 is positioned within the transparent layer 104 that is formed into the body). In an embodiment, the three-dimensional (3D) object 100 includes a translucent layer 105 within and/or on the transparent layer 104. For example, the translucent layer 105 may include translucent paint applied or painted on the transparent layer 104 to provide a perceived color of the reflected light to the guests 12.

The retro-reflective object 102 may include or be a retro-reflective layer similar to the retro-reflective layers 26, 30 described above with respect to FIG. 1. For instance, the retro-reflective object 102 may include the retro-reflective layer, where the retro-reflective layer is altered (e.g., bent, shaped, cut) into a desired two-dimensional (2D) or 3D shape (e.g., key shape shown in FIG. 2 or any other suitable shape). In an embodiment, the retro-reflective object 102 may include a non-retro-reflective object covered with the retro-reflective layer. In any case, the retro-reflective object 102 may be positioned behind the transparent layer 104 relative to a perspective of guests 12 (e.g., a first guest 12A) and may be configured to reflect direct light with minimal reflected light scattering.

In FIG. 2, the transparent layer 104 and/or the retro-reflective layer include at least one non-planar portion. Further, the transparent layer 104 and the retro-reflective layer are positioned to provide a visual effect of the retro-reflective object 102 being set back or separated from the transparent layer 104. For example, the retro-reflective object 102 may be separated from the transparent layer 104 by a gap. Advantageously, and particularly with the transparent layer 104 formed into the body, this arrangement may provide a visual effect of the retro-reflective object 102 being within the body.

For example, in FIG. 2, the transparent layer 104 is formed into the body of an animated character (e.g., 3D object 100), and the retro-reflective object 102 (e.g., a key) is positioned within the body to provide the visual effect of a glowing object within the body. Together, the transparent layer 104 and the retro-reflective object 102 are part of the 3D object 100, which may be located within an attraction. As discussed herein, guests 12A, 12B, 12C (collectively guests 12) may partake in a game or other attraction, and may be tasked with discovering or finding a hidden object or objects (e.g., the retro-reflective object 102) in the attraction. As shown, the guests 12 may be at various positions around the attraction (e.g., various positions along a track of a roller coaster or omni mover ride). In an embodiment the transparent layer 104 may extend circumferentially about the retro-reflective object 102 (e.g., the body is transparent on all sides or multiple sides), such that the guests 12 in various positions around the 3D object 100 may be capable of finding or discovering the retro-reflective object 102 within. For example, the first guest 12A using a first light source 112 may direct light 114 through the transparent layer 104 formed into the body and at the retro-reflective object 102, where then the light 116 is reflected back to the first guest 12A, giving the effect the retro-reflective object 102 is glowing within the body.

Likewise, a third guest 12C positioned on an opposite side of the 3D object 100 relative to the first guest 12A may also use a second light source 120 to direct light 122 through the transparent layer 104 formed into the body and at the retro-reflective object 102, where then the light 124 is reflected back to the third guest 12C, giving the effect the retro-reflective object 102 is glowing within the body. As will be appreciated, upon application of light (e.g., light 114, 122), the retro-reflective object 102 may reflect light (e.g., light 116, 124) back toward the light source (e.g., the first and second light sources 112, 120) with minimal light scattering. As such, a second guest 12B, who may carry a third light source 118 that is not directing its light 126 at the retro-reflective object 102, will not experience (e.g., perceive) the visual effect of retro-reflective object 102 glowing due to the application of the light 114, 122 originating from other locations (e.g., away from the second guest 12B). In this way, the second guest 12B within the attraction with the first and third guests 12A, 12C, may not inadvertently perceive the retro-reflective object's 102 glowing visual effect due to the actions of the first and third guests 12A, 12C and may perceive (e.g., only perceive) the retro-reflective object's 102 glowing visual effect when (e.g., while; in response to) the third light source 118 is positioned (e.g., moved or repositioned as compared to FIG. 2) to direct its light 126 at the retro-reflective object 102.

In an embodiment, the guests 12 may use mobile devices with light capabilities as the light sources 112, 118, 120. For instance, the first guest 12A may turn on or otherwise activate a flashlight application of a mobile telephone to direct light at the retro-reflective object 102. Further, in an embodiment, the mobile device may be configured to capture a photograph of the retro-reflective object 102 while using the lighting from the mobile device (e.g., flash). In this way, the retro-reflective object 102 within the photograph captured of the retro-reflective object 102 may appear to have a glowing visual effect. In an embodiment, the first guest 12A may use the photograph to indicate or provide verification that a hidden object (e.g., retro-reflective object 102) has been found, and may receive achievements (e.g., points, prizes) associated with the retro-reflective object 102. It should be noted the use of a cellular device as a light source is not limited to the retro-reflective object 102, and a cellular device with lighting capabilities may be used for any retro-reflecting application as discussed within this disclosure.

In an embodiment, the guests 12 may use an application on mobile devices to perform tasks associated with the attraction (e.g., game, ride). For example, the attraction may task the guests 12 with finding specific hidden objects, where the hidden objects may include the retro-reflective object 102. The hidden object is not limited to the retro-reflective object 102 and may additionally or alternatively include a planar or flat retro-reflective object, similar to as discussed above in FIG. 1. In any case, the application may be configured to access the camera and/or flashlight capabilities of the mobile devices used by the guests 12. Upon directing the flashlight of the mobile devices at the hidden object, the application may be configured to receive data (e.g., from the camera) indicative of the hidden object identification. For example, the application may use data indicative of the hidden objects shape, color, size, location, retro-reflective properties, or a combination thereof to identify the hidden object found. Upon receiving information of the identification of the hidden object, the application may mark that hidden object has been found by the mobile device. Further, the application may award achievements (e.g., points, prizes) for each hidden object found by the guests 12 using the application and the mobile device. The application may further output an indication that the hidden object has been found on the display of the mobile device.

It should be understood that this disclosure covers all retro-reflective objects 102 positioned within any suitable 3D object 100, and is not limited to the specific configuration and design of objects as discussed above. For example, the 3D object 100 and the retro-reflective object 102 may include or have an appearance of at least part of an animated figure, a costume, a show prop, a vehicle, a building, animal, word, number, and/or any other structure or object.

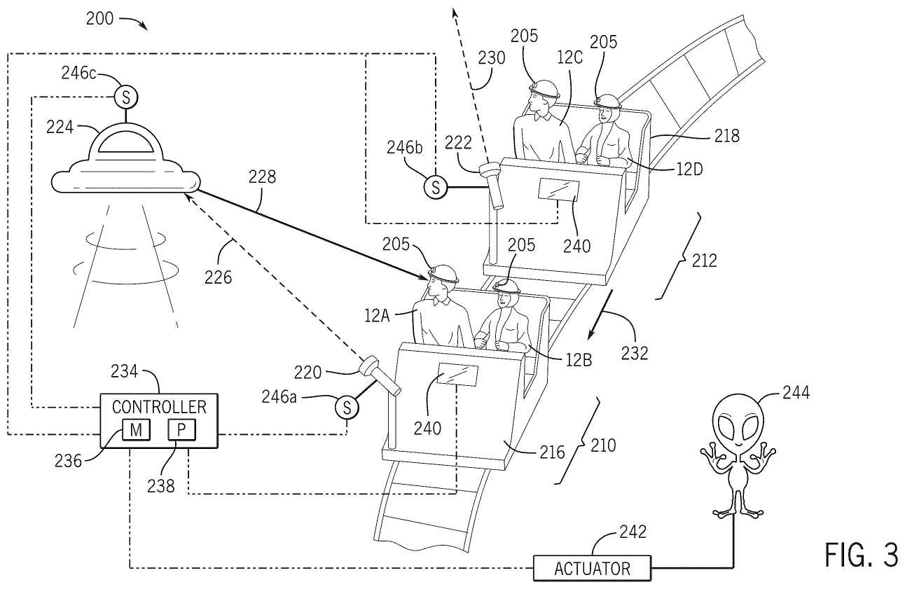

FIG. 3 illustrates an embodiment of an attraction 200 utilizing a retro-reflective material, such as the retro-reflective material as discussed above in FIGS. 1 and 2. That is, FIG. 3 shows the attraction 200 (e.g., rollercoaster, omni mover ride) configured to transport or otherwise move guests 12A, 12B, 12C, 12D (collectively guests 12) through an attraction environment. In the illustrated embodiment, each vehicle 216, 218 of the attraction 200 may be configured to move a guest group 210, 212 (e.g., each guest group 210, 212 including one or more of the guests 12). Each vehicle 216, 218 may include or be coupled to one or more light sources 220, 222 (e.g., flashlights, headlights) configured to be carried and/or manipulated (e.g., manually or automatically moved) based on a desired light direction of the guest group 210, 212. In an embodiment, each vehicle 216, 218 may have multiple light sources, such as one or more light sources for each guest 12 of a respective vehicle 216, 218. In any case, the one or more light sources 220, 222 may be carried and/or manipulated to direct light at various objects and/or locations throughout the attraction 200.

In an embodiment, the attraction 200 may include one or more planar retro-reflective objects and/or one or more 3D retro-reflective objects configured to portray a glowing visual effect upon application of direct light. In an embodiment, while riding and/or participating in the attraction 200, the guests 12 may be tasked with finding or discovering hidden retro-reflective objects 224 in areas where the vehicles 216, 218 are transported through. For example, a first vehicle 216 carrying a first guest group 210 moving in a direction 232 may point or manipulate a first light source 220 to direct light 226 at various locations within the attraction 200 to discover or find hidden retro-reflective objects 224. Upon using the first light source 220 to direct the light 226 at one of the retro-reflective objects 224, reflected light 228 may be directed back towards the first guest group 210, and not the second guest group 212. In this way, the retro-reflective object 224 may appear to have a glowing visual effect in comparison to other objects of the attraction environment. As such, the first guest group 210 may be alerted or are otherwise aware of the hidden retro-reflective object 224.

Indeed, due to the directional properties of the hidden retro-reflective objects 224, upon application of the light 226 originating from the first light source 220, guests 12C, 12D of a second guest group 212 may not perceive the glowing visual effect produced by the retro-reflective object 224. As such, the second guest group 212 may not be accidently alerted to a location of the retro-reflective object 224 without manipulation of a second light source 222 to direct light 230 towards the retro-reflective object 224, thereby improving the guest experience. For example, in embodiments where the attraction 200 includes multiple vehicles 216, 218 traveling in the direction 232, the first vehicle 216 entering an area first may not alert guests of the second guest group 212, who are entering the area at a later time, of the location of the retro-reflective object 224.

In an embodiment, each guest 12 of the attraction 200 may receive a wearable light source 205 configured to direct light towards the retro-reflective objects 224. For example, the guests 12 may wear a helmet, glasses, headband, and/or any other suitable head or body mounted object including a light emitter. In this way, the light emitting from the head or body mounted light source may be reflected back (e.g., reflected back from a retro-reflective object 224) to eyes of the guests 12. As will be appreciated, a proximity of a head mounted light source and respective eyes of the guests 12 may create a brighter or more intense glowing visual effect from the retro-reflective object 224 as perceived by the respective guest 12. It is noted that the mounted location of the light source is not limited to a head of the guest 12, and any suitable location is covered in this disclosure. Further, the use of the wearable light source 205 source in the attraction 200 may enable the guests 12 to use their hands for other attraction 200 activities. For example, the guest 12 using the wearable light source 205 may be capable of using hands to operate a ride, operate a feature of a ride (e.g., a blaster), interact with a user interface, interact with another guest 12, or a combination thereof.

In an embodiment, in response to an application of direct light 226 from a light source to the retro-reflective object 224, the attraction 200 may be configured output an action. For example, in response to one of the guests 12A, 12B directing light 226 at the retro-reflective object 224, the attraction 200 (e.g., a controller 234) may signal or otherwise indicate to the guests 12A, 12B the retro-reflective object 224 has been found. For instance, the attraction 200 may include the controller 234 (e.g., control system) coupled to sensor 246a (e.g., light source sensors, position sensors) and/or sensor 246b (collectively referred to as sensors 246) configured to detect the application of direct light to the retro-reflective object 224 from the light source 220 (and/or the wearable light sources 205). In an embodiment, the controller 234 may be located offboard from the attraction 200 and/or the vehicles 216, 218, such as in a control room and communicatively coupled (e.g., wired or wireless) to the sensors 246.

The sensors 246 may transmit (e.g., via communication lines, such as electric cables or fiber optic cables) feedback (e.g., signals, data) to the controller 234. The controller 234 may include one or more processors 238 and a memory device 236. In an embodiment, the controller 234 may include additional components, such as receivers and transmitters for receiving or transmitting data (e.g., via radiofrequency, optical frequency, other communication frequencies, or any combination thereof).

In an embodiment, in response to a determination of the application of direct light 226, 230 to the retro-reflective object 224, the controller 234 may be configured to output an indication that the retro-reflective object 224 has been found by a respective guest 12A, 12B or a respective guest group 210, 212. The attraction may include one or more visual displays and/or user interfaces 240 configured to display information related to the retro-reflective object 224. For example, each vehicle 216, 218 may include one or more visual displays and/or user interfaces 240 to present information to the respective guests 12 within each vehicle 216, 218. For example, upon application of direct light 226 from the first light source 220 located on the vehicle 216, the controller 234 may determine (e.g., determine using the feedback obtained from sensors 246) the guest group 210 has found the hidden retro-reflective object 224. As such, the controller 234 may generate and output information on the one or more user interfaces 240 indicating the guest group 210 has found the hidden retro-reflective object 224. For example, the controller 234 may generate and output a visual on the one or more user interfaces 240 congratulating the guest group 210 on finding the hidden retro-reflective object 224. In an embodiment, the controller 234 may generate and output a visual of information (e.g. a backstory, an obtained amount of points, a prize, a new task, a new clue) related to the retro-reflective object 224. In an embodiment, the controller 234 may count or provide credit in response to (e.g., only if) the application of direct light 226 remains pointed at the retro-reflective object 224 for a period of time (e.g., 1 second, 2 seconds, 3 seconds, or other suitable time threshold) In this way, the guests 12 may not receive an indication based on a finding of hidden retro-reflective objects 224 while only quickly scanning or moving the light sources 220, 222 from one location to another location.

Furthermore, upon a determination by the controller 234 that a particular guest 12A, 12B, 12C, and/or 12D or a particular guest group 210 or 212 has found a hidden retro-reflective object 224 (e.g., has directed light 226, 230 at a hidden retro-reflective object 224,) the particular guest 12A, 12B, 12C, and/or 12D or the particular guest group 210 or 212 (e.g., the particular group 210, 212 and/or the guests 12 within the particular guest group 210, 212) may receive achievements (e.g., points, prizes) associated with the found retro-reflective object 224. For example, upon application of light 226 to the retro-reflective object 224, the controller 234 may be configured to associate points (e.g., give points) and/or a score with the first guest group 210. In an embodiment, the attraction 200 may task the guests 12 with obtaining the most points or the highest score throughout the attraction 200 or a theme park (e.g., multiple attractions). The controller 234 may include or access identification data (e.g., in the memory device 236) and one or more identification measures (e.g., facial recognition, voice recognition, unique guest number, or other unique identifiers). Upon identification of the guest 12A, 12B, 12C, and/or 12D via, for example, comparing the data from the identification measures to the identification data stored in the memory device 236, the controller may then associate the identified guest 12A, 12B, 12C, and/or 12D with a respective light source (e.g., light sources 220, 222) and/or vehicle 216, 218. The controller 234 may then associate achievements to a respective guest 12A, 12B, 12C, and/or 12D based on a found retro-reflective object 224.

In the illustrated example, the first vehicle 216 with the first guest group 210 may be competing against the second vehicle 218 with the second guest group 212. In an embodiment, each guest 12 may compete against each with separate light sources for each guest 12. For example, the minimal light scattering of the retro-reflective objects 224 may inhibit the guests 12A, 12B from finding the retro-reflective objects 224 due to the actions (e.g., shining light 230) of guests 12C, 12D (e.g., without directing light at the retro-reflective object 224).

In an embodiment, in response to a determination of the application of direct light 226, 230 to the retro-reflective object 224, the controller 234 may be configured to send instructions (e.g., control signals), to operate additional attraction elements 244. For example, upon application of direct light 226 to the retro-reflective object 224 from the first light source 220, the controller 234 may determine (e.g., determine using data obtained from sensors 246) the retro-reflective object 224 has been found, and in response to the determination, send instructions to an actuator 242. Upon receiving instructions from the controller 234, the actuator 242 may manipulate or otherwise move the attraction element 244. In an embodiment, the controller 234 may further send instructions to any number of additional attraction elements, including speakers, dispensing machines, lights, and so forth.

In an embodiment, the light sources 220, 222 may operate in various manners depending on a desired or assigned trait of a guest 12 or a guest group 210, 212. For example, each guest 12 or guest group 210, 212 may choose or otherwise be assigned a specific trait (e.g., a character trait, level) associated with the attraction 200. For instance, the first guest group 210 within the first vehicle 216 may be assigned a specific fantasy character (e.g., heroes), while the second guest group 212 within the second vehicle 218 may be assigned another fantasy character (e.g., villains). In an embodiment, certain traits may be associated with enablement of certain actions within the attraction 200. For example, the application of light 226 from the first light source 220 of the first vehicle 216 (with an associated hero trait) onto the retro-reflective object 224 may cause the controller 234 to produce a trait specific, guest specific, and/or vehicle specific output (e.g., actuation of the attraction element 244). On the other hand, in an embodiment, the application of light 230 from the second light source 222 of the second vehicle 218 (with associated villain trait) onto the same retro-reflective object 224 may cause the controller 234 to produce a different trait specific, guest specific, and/or vehicle specific output (e.g., no actuation of attraction element 244; actuation of a different attraction element 244; different movement and/or verbiage provided by the attraction element 244) or not output at all. Further, the light sources 220, 222 may output light of different colors (e.g., blue and red), which may represent the desired or assigned train, for example.

In an embodiment, the light sources 220, 222 of the attraction 200 may be selectively operated based on a perceived direction (e.g., position and/or orientation) of the light sources 220, 222 (based on feedback received from the sensors 246a, 246b) and/or an associated trait of the one or more guests of the guests 12, the guest group 210, 212 and/or the vehicle 216, 218. For example, the first guest group 210 may be associated with a specific trait (e.g., character, level) and may be tasked with finding hidden retro-reflective objects 224 associated with the specific trait. Further, the first light source 220, may be configured in an off operating mode (e.g., no light) until a determination that the first light source 220 is directed towards a hidden retro-reflective object 224 associated with the specific trait. Upon determining the first light source 220 is directed towards the retro-reflective object 224 associated with the specific trait, the controller 234 may send instructions (e.g., a control signal) to the first light source 220 to operate the first light source 220 in an on mode (e.g., light on). In this way, the first light source 220 may only shine (e.g., direct light) at a retro-reflective object 224 associated with the specific trait, and not, for example, retro-reflective objects 224 not associated with the specific trait and/or associated with a different trait. The second light source 222 may be operated in a similar manner, but for a different specific trait, for example.

While FIG. 3 provides an example in a context of a ride attraction, it should be appreciated that these techniques may be implemented in any suitable attraction or venue, such as in a walkthrough attraction in which the guests 12 walk along a pathway, a conveyor attraction in which the guests 12 are carried on a conveyor, a show performance, and so forth.

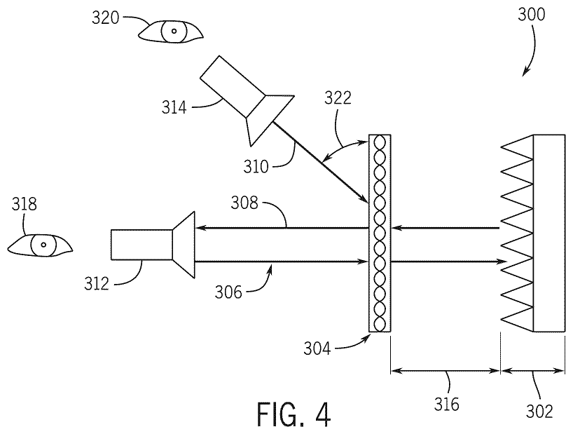

FIG. 4 illustrates an embodiment of a retro-reflective object 300 (e.g., material, layer, show set). For example, the retro-reflective object 300 may include a retro-reflective layer 302 configured to reflect direct light 306 back to a first light source 312 with minimal or no scattering. As described herein, the retro-reflective layer 302 may include a corner retro-reflective layer or a spherical (e.g., cat's eye) retro-reflective layer. The retro-reflective object 300 may also include a scrim layer 304 (e.g., semi-transparent screen), configured to cover and/or shade the retro-reflective layer 302. For example, the scrim layer 304 may at least partially block direction of light to the retro-reflective layer 302 and/or from the retro-reflective layer 302. As such, the scrim layer 304 may block the view of the retro-reflective object 10, and the accompanying visual effect, at certain viewing and/or light angles. In an embodiment, the scrim layer 304 may include decorations, such as a translucent layer defining an image. For example, the retro-reflective layer 302 may be separated from the scrim layer 304 by a gap. Advantageously, this arrangement may provide a visual effect of the scrim layer 304 blending into an environment (e.g., the scrim layer 304 may be within a frame to appear to be a painting hanging on a wall in the environment). In any case, without application of light 306 through the scrim layer 304, the gap remains dark and the retro-reflective layer 302 does not reflect light toward guest viewpoints 318, 320 (e.g., a viewpoint of guests 12A, 12B, 12C, and/or 12D). Instead, from guest viewpoints 318, 320, the scrim layer 304 may be viewed as a part of the environment.

Upon application of direct light 306 from a first light source 312, light 306 may enter through the scrim layer 304, through a distance 316 between the scrim layer 304 and the retro-reflective layer 302, towards the retro-reflective layer 302. Upon reaching the retro-reflective layer 302, the light 308 may be reflected back toward the first light source 312, with minimal light scattering. The first guest viewpoint 318 proximate or near the first light source 312 may view the reflected light 308 through the scrim layer 304. In an embodiment, the retro-reflective layer 302 may have a shape (e.g., a key), which may be revealed or visible at the first guest viewpoint 318 via the light 308 reflected back toward the first light source 312. In this case, a guest at the first guest viewpoint 318 may observe the light 308 through the scrim layer 304 due to directional reflecting of the retro-reflective layer 302, but a guest from the second guest viewpoint 320 may not view the light 308 reflected back toward the first light source 312 (or view the shape or other visual effects provided by the retro-reflective layer 302).

As will be appreciated, the scrim layer 304 at least partially obscures the retro-reflective layer 302 from viewpoints without the application of direct light 306 in a crosswise direction relative to a plane of the scrim layer 304. For example, a second light source 314 directing light 310 at an acute angle (e.g., an angle greater than 0 degrees and less than 90 degrees) relative to the plane of the scrim layer 304 may not penetrate or otherwise pass through the scrim layer 304. In this way, a guest at the second guest viewpoint 320 may not be capable of viewing the retro-reflective layer 302 and/or the retro-reflective visual effect, even with shining the light 310 toward the scrim layer 304. Indeed, the distance 316 between the scrim layer 304 and the retro-reflective layer 302 may be adjusted (e.g., increased, decreased) based on a desired ability of a guest from the first guest viewpoint 318 and/or the second guest viewpoint 320 to view the visual effect of the retro-reflective layer 302. For example, the distance 316 between the scrim layer 304 and the retro-reflective layer 302 may be any distance (e.g., between approximately 0.25 to 2 meters, 0.5 to 1 meter, or other range) suitable to at least partially obscure the retro-reflective layer 302 from perspective viewpoints without the direct application of the light 306. In an embodiment, the retro-reflective layer 302 may be three-dimensional (3D) and positioned behind the scrim layer 304, relative to the respective guest viewpoints 318, 320.

Further, the scrim layer 304 may include scrim holes within the scrim layer itself that may allow light 308 and light 306 to pass through. The scrim holes may include any shape (e.g., circular, triangular, shark tooth, rectangular, hexagonal, bobbinet scrim shaped) and/or size suitable to achieve a desired visual effect from the retro-reflective layer 302.

Although the illustrated embodiment shows the retro-reflective object 300 without a translucent layer (e.g., the translucent layer 40, 105) or a transparent layer (e.g., transparent layer 24, 104), it will be appreciated the retro-reflective object 300 may include a translucent layer and/or a transparent layer in any suitable location, such as between the scrim layer 304 and the retro-reflective layer 302. Additionally or alternatively, the retro-reflective object 300 may include one or more opaque elements, as similarly described above.

While only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any features shown and described with reference to FIGS. 1-4 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An entertainment attraction for an entertainment venue, the entertainment attraction comprising:
a retro-reflective object comprising:
a retro-reflective layer configured to directionally reflect light;
a transparent layer configured to enable passage of the light towards the retro-reflective layer;
a translucent layer overlaid onto the transparent layer and configured to provide the retro-reflective object with one or more light effects; and
a light source configured to direct the light to the retro-reflective object.

2. The entertainment attraction of claim 1, wherein the translucent layer is configured to provide the retro-reflective object with a color effect as the one or more light effects.

3. The entertainment attraction of claim 2, wherein the translucent layer is a translucent paint or a translucent sticker, and wherein the translucent layer is configured to define an image.

4. The entertainment attraction of claim 3, comprising an opaque element configured to at least partially define the image.

5. The entertainment attraction of claim 1, wherein the light source is configured to be manipulated by a guest of the entertainment attraction.

6. The entertainment attraction of claim 1, comprising:
a sensor, configured to detect an application of the light to the retro-reflective object; and
a controller communicatively coupled to the sensor, wherein the controller is configured to:
identify the application of the light to the retro-reflective object, and based on identifying the application of the light to the retro-reflective object:
indicate to a guest of the entertainment attraction that the retro-reflective object has been found.

7. The entertainment attraction of claim 1, wherein the entertainment attraction is a ride attraction, and wherein the light source is coupled to a vehicle of the ride attraction.

8. The entertainment attraction of claim 1, wherein the retro-reflective object is a three-dimensional (3D) object, and wherein the transparent layer, the translucent layer, or both are configured to surround the retro-reflective layer.

9. An entertainment attraction for an entertainment venue, the entertainment attraction comprising:
a retro-reflective object comprising:
a retro-reflective layer configured to directionally reflect light;
a transparent layer configured to enable passage of the light towards the retro-reflective layer; and
a translucent layer overlaid onto the transparent layer and configured to provide the retro-reflective object with one or more light effects;
a sensor configured to detect an application of the light to the retro-reflective object; and
a controller communicatively coupled to the sensor, wherein the controller is configured to:
identify the application of the light to the retro-reflective object, and based on identifying the application of the light to the retro-reflective object:
provide, via a display associated with a guest of the entertainment attraction, an indication associated with the retro-reflective object.

10. The entertainment attraction of claim 9, wherein the entertainment attraction is a walkthrough attraction or a ride attraction.

11. The entertainment attraction of claim 9, wherein the light is provided by a light source configured to be held by the guest.

12. The entertainment attraction of claim 11, wherein the light source comprises a light source sensor communicatively coupled to the controller, wherein the controller is configured to selectively operate the light source based on feedback received from the light source sensor.

13. The entertainment attraction of claim 12, wherein the feedback is indicative of a position or an orientation of the light source.

14. The entertainment attraction of claim 9, comprising a light source configured to apply the light to the retro-reflective object, wherein the controller is configured to selectively operate the light source based on an associated trait of the guest.

15. The entertainment attraction of claim 9, wherein the retro-reflective object is a three-dimensional (3D) object.

16. A retro-reflective object for an entertainment venue, the retro-reflective object comprising:
a retro-reflective layer configured to receive light from a light source and directionally reflect the light back towards the light source;
a scrim layer configured to at least partially block passage of light to the retro-reflective layer, from the retro-reflective layer, or both;
a transparent layer configured to enable passage of the light towards the retro-reflective layer; and
a translucent layer overlaid onto the scrim layer and configured to provide the retro-reflective object with one or more light effects.

17. The retro-reflective object of claim 16, wherein the light source is configured to be carried, manipulated, or both by a guest of the entertainment venue.

18. The retro-reflective object of claim 16, comprising an opaque element configured to at least partially define an image of the retro-reflective object.

19. The retro-reflective object of claim 16, wherein the retro-reflective layer is a three-dimensional (3D) object, and the transparent layer, the translucent layer, or both, at least partially surround the retro-reflective layer.

20. The retro-reflective object of claim 19, wherein the scrim layer is separated from the retro-reflective layer.
